(19) United States
(12) Patent Application Publication
(10) Pub. No.: US 2025/0016745 A1
(43) Pub. Date: Jan. 9, 2025

(54) BLE broadcast communication method, device and system

(71) Applicant: Zgmicro Wuxi Corporation, Wuxi Jiangsu (CN)

(72) Inventor: Bin XU, Wuxi (CN)

(73) Assignee: Zgmicro Wuxi Corporation, Wuxi (CN)

(21) Appl. No.: 18/444,779

(22) Filed: Feb. 19, 2024

(30) Foreign Application Priority Data
Jul. 7, 2023 (CN) 2023108354747

(51) Int. Cl. H04W 72/0446; H04W 84/18

(52) U.S. Cl. CPC H04W 72/0446; H04W 84/18

(57) ABSTRACT

BLE broadcast communication methods, systems, and devices are described. A BLE broadcast communication method is applied to a master device. The master device configures a reverse communication enable instruction in the BIS packet to indicate whether a reverse communication is permitted in a current isochronous interval while the master device performs a broadcast communication with one or more slave devices. Moreover, a shared reverse control time slot is provided in the isochronous interval. If the reverse communication is permitted in the current isochronous interval, any one of the slave devices requiring the reverse communication may transmit the reverse control packet based on the isochronous channel in the shared reverse control time slot, and the master device may receive the reverse control packet in the shared reverse control time slot without the need to allocate an exclusive time slot for each slave device for reverse communication, thereby realizing functions of bi-directional communication and the slave device controlling the master device when information of the slave devices is uncertain, and improving controllability.

### CROSS-REFERENCE OF RELATED APPLICATIONS

The present invention claims priority of Chinese Patent Application No. 2023108354747 filed in China on Jul. 7, 2023, the entire contents of which are incorporated herein by reference.

### BACKGROUND OF THE INVENTION

### Field of the Invention

The present invention relates to the field of wireless communication technology and, in particular, to a Bluetooth Low Energy or BLE broadcast communication method, a BLE broadcast communication method device or a BLE broadcast communication method system.

### Description of the Related Art

Wireless audio technology has been widely loved by people due to unrestricted talk and audio enjoyment brought by the wireless audio technology. In particular, Bluetooth Low Energy (BLE) audio technology, which adopts Isochronous Channel protocols, namely, a Connected Isochronous Stream (CIS) link and a Connected Isochronous Group (CIG) protocol consisting of a plurality of CIS links for point-to-point communication, and a Broadcast Isochronous Stream (BIS) link and a Broadcast Isochronous Group (BIG) protocol consisting of a plurality of BIS links for point-to-multipoint communication, brings people lower power consumption, lower cost, higher quality, lower latency, and richer wireless audio service. For example, an Auracast function for BLE broadcast released newly by a Bluetooth Special Interest Group (BLE SIG) is a wireless music sharing application based on the BIG protocol and a public broadcast profile (PBP) protocol.

Main application scenarios of the Auracast function are public places such as airports, stations, shopping malls, cafes, and muted TVs. Anyone in the public places can use their own Bluetooth audio device to access an Auracast system and listen to music at any time. In these application scenarios, an Auracast receiving device may be a wireless earphone or wireless hearing aid for any audience. It does not require the Auracast receiving device to feedback status information to an Auracast transmitting device, and it does not require the Auracast receiving device to reverse control the Auracast transmitting device and indirectly control the other Auracast receiving devices. The Auracast transmitting device also cannot receive any information from the Auracast receiving device. Therefore, PBP and BIG do not support point-to-multipoint reverse communication or bidirectional communication, which results in the BIG-based Auracast or PBP not being able to be applied to music sharing party scenarios or multi-room distributed speaker scenarios that require interactive control functionality.

Therefore, the traditional BLE audio broadcast technology does not solve the problem of bidirectional communication in the audio broadcasting system, especially the problem of how to perform reverse control and bidirectional communication in the point-to-multipoint audio broadcasting system under the condition that information of the slave device is uncertain, a system controllability is not good and a user experience is poor.

### SUMMARY

A purpose of the present invention is to provide a BLE broadcast communication method, a BLE broadcast communication device and a BLE broadcast communication system, which can improve controllability of a BLE broadcast communication system.

To achieve the purpose, according to one aspect of the present invention, a BLE audio broadcasting method is provided. The BLE broadcast method is applied to a master device configured to perform a broadcast communication with one or more slave devices in a plurality of consecutive isochronous intervals based on an isochronous channel. The isochronous interval is provided with a data broadcast time slot and a shared reverse control time slot. The shared reverse control time slot is a time slot that is occupiable by any one of the slave devices when transmitting a reverse control packet. The BLE broadcast method comprises: configuring a reverse communication enable instruction in a BIS packet to be broadcast, the reverse communication enable instruction being used to indicate whether a reverse communication is permitted in the current isochronous interval; broadcasting the BIS packet in the data broadcast time slot; and receiving based on the isochronous channel in the shared reverse control time slot of the current isochronous interval to obtain the reverse control packet transmitted by one of the slave devices when the reverse communication enable instruction indicates that the reverse communication is permitted in the current isochronous interval under the condition that each slave device is not required to be allocated with an exclusive time slot for the reverse communication.

According to another aspect of the present invention, a BLE broadcast method is provided. The BLE broadcast communication method is applied to a slave device configured to perform a broadcast communication with a master device in a plurality of consecutive isochronous intervals based on an isochronous channel. The isochronous channel is provided with a data broadcast time slot and a shared reverse control time slot. The shared reverse control time slot is a time slot that is occupiable by any one of the slave devices when transmitting a reverse control packet. The BLE broadcast communication method comprises: receiving a BIS packet broadcast by the master device in the data broadcast time slot and obtaining a reverse communication enable instruction carried in the BIS packet, the reverse communication enable instruction being used to indicate whether a reverse communication is permitted in the current isochronous interval; and transmitting a reverse control packet based on the isochronous channel in the shared reverse control time slot when the reverse communication enable instruction indicates that the reverse communication is permitted in the current isochronous interval and the slave device determines that the reverse communication is required under the condition that this slave device is not required to be allocated with an exclusive time slot for the reverse communication.

According to another aspect of the present invention, a BLE broadcast device is provided. The BLE broadcast communication device is used as a master device configured to perform a broadcast communication with one or more slave devices in a plurality of consecutive isochronous intervals based on an isochronous channel. The isochronous interval is provided with a data broadcast time slot and a shared reverse control time slot. The shared reverse control time slot is a time slot that is occupiable by any one of the slave devices when transmitting a reverse control packet. The master device is further configured to: configure a reverse communication enable instruction in a BIS packet to be broadcast, the reverse communication enable instruction being used to indicate whether a reverse communication is permitted in the current isochronous interval; broadcast the BIS packet in the data broadcast time slot; and receive based on the isochronous channel in the shared reverse control time slot of the current isochronous interval to obtain the reverse control packet transmitted by one of the slave devices when the reverse communication enable instruction indicates that the reverse communication is permitted in the current isochronous interval under the condition that each slave device is not required to be allocated with an exclusive time slot for the reverse communication.

According to another aspect of the present invention, a BLE broadcast device is provided. The BLE broadcast communication device is used as a slave device configured to perform a broadcast communication with a master device in a plurality of consecutive isochronous intervals based on an isochronous channel. The isochronous interval is provided with a data broadcast time slot and a shared reverse control time slot. The shared reverse control time slot is a time slot that is occupiable by any one of the slave devices when transmitting a reverse control packet. The slave device is further configured to: receive a BIS packet broadcast by the master device in the data broadcast time slot and obtain a reverse communication enable instruction carried in the BIS packet, the reverse communication enable instruction being used to indicate whether a reverse communication is permitted in the current isochronous interval; and transmit a reverse control packet based on the isochronous channel in the shared reverse control time slot when the reverse communication enable instruction indicates that the reverse communication is permitted in the current isochronous interval and the slave device determines that the reverse communication is required under the condition that this slave device is not required to be allocated with an exclusive time slot for the reverse communication.

According to another aspect of the present invention, a BLE broadcast system is provided. The BLE broadcast system comprises a master device and one or more slave devices. The master device is configured to perform a broadcast communication with the slave devices in a plurality of consecutive isochronous intervals based on an isochronous channel. The isochronous interval is provided with a data broadcast time slot and a shared reverse control time slot. The shared reverse control time slot is a time slot that is occupiable by any one of the slave devices when transmitting a reverse control packet. The master device is configured to: configure a reverse communication enable instruction in a BIS packet to be broadcast, the reverse communication enable instruction being used to indicate whether a reverse communication is permitted in the current isochronous interval. The slave device is configured to: receive the BIS packet broadcast by the master device in the data broadcast time slot of the current isochronous interval and obtain the reverse communication enable instruction carried in the BIS packet; and transmit a reverse control packet based on the isochronous channel in the shared reverse control time slot when the reverse communication enable instruction indicates that the reverse communication is permitted in the current isochronous interval and the slave device determines that the reverse communication is required under the condition that this slave device is not required to be allocated with an exclusive time slot for the reverse communication. The master device is further configured to: receive based on the isochronous channel in the shared reverse control time slot of the current isochronous interval to obtain the reverse control packet transmitted by one of the slave devices.

In the embodiments of the present invention, while the master device and the slave devices of the BLE broadcast communication system performs the BLE BIS data broadcast communication, the master device also configure the reverse communication enable instruction in the BIS packet to be broadcast, and the reverse communication enable instruction is used to indicate whether the reverse communication is permitted in the current isochronous interval. Moreover, the shared reverse control time slot is provided in the isochronous interval. When the reverse communication enable instruction indicates that the reverse communication is permitted in the current isochronous interval, any one of the slave devices requiring the reverse communication can occupy the shared reverse control time slot to transmit the reverse control packet based on the isochronous channel, and the master device does not need to allocate an exclusive time slot for the reverse communication for each slave device. The reverse control packet can be received in the shared reverse control time slot, thus realizing the functions of bi-directional communication and the slave device controlling the master device. Therefore, compared with the prior art, the embodiments of the present invention can realize the reverse control and the bidirectional communication of a point-to-multipoint broadcast system when information of the slave devices is uncertain, thereby improving the controllability of the BLE broadcast communication system.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings wherein:

FIG. 1 is a schematic diagram of a BLE broadcast communication system according to one embodiment of the present invention;

FIG. 2 is a schematic flow diagram of a BLE broadcast communication method applied to a master device according to one embodiment of the present invention;

FIG. 3 is a schematic flow diagram of a BLE broadcast communication method applied to a slave device according to one embodiment of the present invention;

FIG. 4 is a schematic diagram of a time slot structure of the BLE broadcast communication system according to one embodiment of the present invention;

FIG. 5 is a schematic diagram of one type of header of a packet according to one embodiment of the present invention;

FIG. 6 is a schematic diagram of another type of header of the packet according to one embodiment of the present invention;

FIG. 7 is a schematic diagram of a format of one or more reverse control flags according to one embodiment of the present invention;

FIG. 8 is a schematic diagram of a payload structure of a BIG Control PDU according to one embodiment of the present invention;

FIG. 9 is a schematic diagram of a BLE broadcast communication device according to one embodiment of the present invention; and

FIG. 10 shows a schematic diagram of an electronic device according to one embodiment of the present invention.

### DETAILED DESCRIPTION OF THE PREFERRED EMBODIMENTS

The detailed description of the invention is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

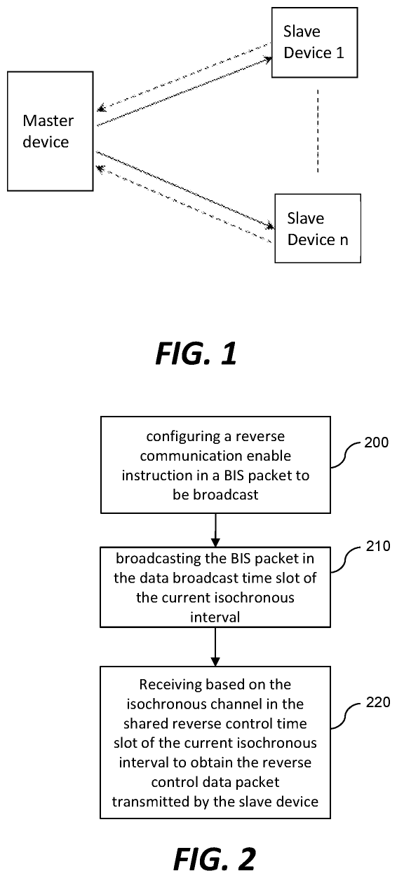

FIG. 1 is a schematic diagram of a BLE broadcast communication system according to one embodiment of the present invention. The BLE broadcast communication system comprises a master device and one or more slave devices. The master device is configured to perform a broadcast communication with one or more slave devices in a plurality of consecutive isochronous intervals based on an isochronous channel. The broadcast communication of BLE can be implemented by using a Bluetooth broadcast-based isochronous channels protocol. Data broadcast by a data source being received by a plurality of data receivers can be realized based on a BLE broadcast isochronous stream (BIS). A communication time of BIS is divided into a plurality of isochronous intervals (ISO Interval), and the data source encapsulates the data to be broadcasted into BIS packets one by one. In a broadcast time slot of each isochronous interval, the data is broadcasted based on the BLE isochronous channel. After the data receiver is synchronized with the data source, the data receiver can scan the BLE isochronous channel in the broadcast time slot to receive the BIS packets broadcast by the data source.

In a current BLE audio technology, the data source uses a BIS Data PDU (Broadcast Isochronous Stream Data Protocol Data Unit) to encapsulate an encoded audio data to form a plurality of BIS packets carrying the encoded audio data. The data receiver receives each BIS packet and decodes the audio data therein for playing music.

A role of the master device is to be the data source in the BLE broadcast communication, and a role of the slave device is to be the data receiver in the BLE broadcast communication. The master device and the slave devices may be realized as various BLE broadcast communication devices, such as cell phones, portable game consoles, portable media playback devices, personal computers, in-car media playback devices, speakers, in-ear headphones, headphones, and the like. It is understood that in some application scenarios, the master device may change its role and be used as the slave device, and the slave device may also change its role and be used as the master device.

The number of the slave devices may be one or more than one. Indeed, the slave devices may be any device receiving the broadcast isochronous stream within the broadcast range, and their number may also vary dynamically. In one embodiment of the present invention, the number of the slave devices is not limited.

The data source in the BLE broadcast communication may also perform a periodic advertising (PA) communication. ACAD (Additional Controller Advertising Data) fields of the periodic advertising may carry BIG information (broadcast isochronous group synchronization information, BIGInfo). The data receiver can receive periodic broadcast and get the BIGInfo. The data receiver can synchronize to the BIG according to the BIGInfo, so as to get the BIS packet on the BIG. Main parameters of the BIGInfo comprise parameters specified by the Bluetooth protocol, such as ISO Interval, BIS Num, NSE, BN, IRC, SDU Size, etc., which are not described herein repeatedly.

As shown in FIG. 2, as a first embodiment of the present invention, a BLE broadcast communication method is provided. The BLE broadcast communication method is applied to a master device performing a broadcast communication in a broadcast isochronous stream BIS manner. The master device and one or more slave devices perform the broadcast communication in a plurality of consecutive isochronous intervals based on an isochronous channel.

The isochronous interval is provided with a data broadcast time slot and a shared reverse control time slot. The shared reverse control time slot is a time slot that can be is occupiable by any one of the slave devices when transmitting a reverse control packet. The method comprises: configuring a reverse communication enable instruction in a BIS packet to be broadcast at 200, the reverse communication enable instruction being used to indicate whether a reverse communication is permitted in the current isochronous interval; broadcasting the BIS packet in the data broadcast time slot of the current isochronous interval at 210; receiving based on the isochronous channel in the shared reverse control time slot of the current isochronous interval to obtain the reverse control packet transmitted by one of the slave devices when the reverse communication enable instruction indicates that the reverse communication is permitted in the current isochronous interval under the condition that each slave device is not required to be allocated with an exclusive time slot for the reverse communication at 220.

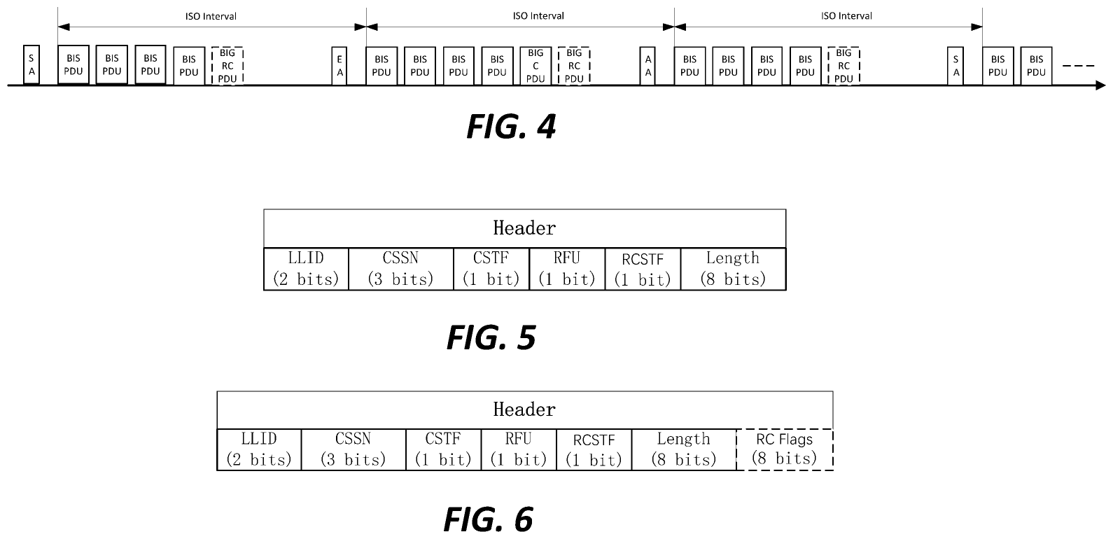

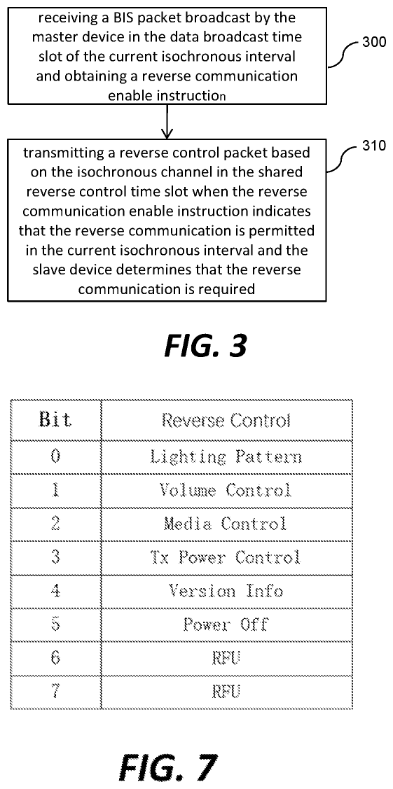

As shown in FIG. 3, as a second embodiment of the present invention, a BLE broadcast communication method is provided. The BLE broadcast communication method is applied to a slave device perform a broadcast communication in a broadcast isochronous stream BIS manner. One or more of the slave devices and the master device perform the broadcast communication in a plurality of consecutive isochronous intervals based on an isochronous channel.

The isochronous interval is provided with a data broadcast time slot and a shared reverse control time slot. The shared reverse control time slot is a time slot that is occupiable by any one of the slave devices when transmitting the reverse control packets. The method comprises: receiving a BIS packet broadcast by a master device in the data broadcast time slot and obtaining a reverse communication enable instruction carried in the BIS packet, the reverse communication enable instruction being used to indicate whether the reverse communication is permitted in the current isochronous interval at 300; transmitting a reverse control packet based on the isochronous channel in the shared reverse control time slot when the reverse communication enable instruction indicates that the reverse communication is permitted in the current isochronous interval and the slave device determines that the reverse communication is required under the condition that this slave device is not required to be allocated with an exclusive time slot for the reverse communication at 310.

FIG. 4 is a schematic diagram of a time slot structure of the BLE broadcast communication system according to one embodiment of the present invention. The data broadcast time slot and the shared reverse control time slot are provided within the isochronous interval (ISO Interval). The data broadcast time slot is used for the master device to broadcast the BIS packet, and a box labeled BIS PDU is used to represent the BIS packet in FIG. 4. Accordingly, the time slot in which the BIS PDU is located represents the data broadcast time slot. The shared reverse control time slot is used for any one of the slave devices to transmit the reverse control packet, the reverse control packet is represented by a box labeled BIG RC PDU in FIG. 4. Accordingly, the time slot in which the BIG RC PDU is located represents the shared reverse control time slot. It will be understood that other time slots may be provided in the isochronous interval for performing other communication actions of the broadcast communication, which is not specifically limited in the present invention.

It will be understood that one or more BIS PDUs may be transmitted in the data broadcast time slot and one or more BIG RC PDUs may also be transmitted in the shared reverse control time slot. The master device and the slave devices perform the broadcast communication in a plurality of isochronous intervals being consecutive in a time domain. The master device generates the BIS packets for broadcasting in the isochronous intervals and configures the reverse communication enable instruction in each BIS packet. In some specific embodiments, the master device may configure the reverse communication enable instruction based on a command input by a user, or may configure the reverse communication enable instruction based on a current operation condition of the system. The reverse communication enable instruction is used to indicate whether the reverse communication is permitted in the current isochronous interval in which this BIS packet is broadcast. The master device can flexibly adjust permission and prohibition of the reverse communication by configuring each BIS packet to dynamically adapt to requirements of the system and the user.

The master device broadcasts the BIS packet in the data broadcast time slot shown in FIG. 4 after the reverse communication enable instruction is configured. As one specific embodiment, the BIS packet may be repeatedly broadcast a number of times in the data broadcast time slot in one isochronous interval.

In some specific embodiments, as shown in FIG. 4, a time domain location of the shared reverse control time slot in the isochronous interval may be after the data broadcast time slot. If the reverse communication enable instruction configured in the BIS packet broadcast in the current isochronous interval indicates that the reverse communication is permitted in the current isochronous interval, the master device, after completing a transmitting action in the data broadcast time slot, enters into the shared reverse control time slot and performs a receiving action in the shared reverse control time slot in order to acquire the reverse control packet transmitted by the slave device on the isochronous channel. It will be understood that in other specific embodiments, the time domain location of the shared reverse control time slot may be set as needed, which is not specifically limited herein.

Accordingly, all of the slave devices in the broadcast communication system receive the BIS packet broadcast by the master device in the data broadcast time slot and obtain the reverse communication enable instruction carried in the BIS packet. Moreover, any one of the slave devices may confirm whether it needs to perform the reverse communication based on various factors such as user input command, system operational needs, etc., and generate the reverse control packet when it confirms that it needs to perform the reverse communication.

When the reverse communication enable instruction obtained by the slave device indicates that the reverse communication is permitted in the current isochronous interval, and the slave device confirms that the reverse communication is required, the slave device may transmit the reverse control packet based on the BLE isochronous channel in the shared reverse control time slot.

In the BLE broadcast communication method according to one embodiment of the present invention, each slave device can transmit the reverse control packet in the shared reverse control time slot, the master device does not need to know each slave device in the BLE broadcast communication system in advance and does not need to allocate an exclusive time slot for reverse communication to each slave device, and the slave devices do not need to register with the master device in advance or request the master device to allocate the exclusive time slots for the present device when the reverse communication is required. The master device enables the reverse communication via the BIS packet, and each slave device can transmit the reverse communication data in time as long as the slave device receives the BIS packet, thereby realizing reverse control and bidirectional communication of a point-to-multipoint broadcast communication system under the condition that the information of the slave device is uncertain, and improving controllability of the BLE broadcast communication system. At the same time, the Bluetooth broadcast system that performs the broadcast communication in a broadcast isochronous stream BIS manner according to one embodiment of the present invention have good compatibility with the existing BLE broadcast Auracast system, and are conducive to implementation and popularization.

In some specific embodiments, the bidirectional control in the BLE broadcast communication can be realized in the present invention. The BLE broadcast communication method further comprises: the master device, while configuring the reverse communication enable instruction, may also configure a control sub-event transmission flag in the BIS packet to be broadcast. The control sub-event transmission flag is used to indicate whether the master device transmits a control packet in the current isochronous interval. The control packet may at least carry relevant information for the master device to perform operational state control of the slave device.

The master device may generate the control packet according to a command input by a user, information from the reverse control packet of the slave device, or other system operational requirements, etc., so as to broadcast the relevant information to the slave device in the broadcast communication system, thereby realizing the bi-directional control between the master and the slave devices by means of the control packet and the reverse control packet.

In some specific embodiments, the isochronous interval is also provided with a control slot for the master device to broadcast the control packet. The BLE broadcast communication method further comprises: entering the control time slot after the data broadcast time slot of the current isochronous interval and broadcasting the control packet based on the isochronous channel in the control time slot when the control sub-event transmission flag indicates that the master device transmits the control packet in the current isochronous interval.

Referring to FIG. 4, in the second isochronous interval, the control packet is represented by a box labeled BIG C PDU, and accordingly, the time slot for transmitting the control packet is the control time slot. As one specific embodiment, a time domain position of the shared reverse control time slot is after the control time slot. The BLE broadcast communication method may be specifically implemented in such a way that if the current isochronous interval does not require the control packet and the current isochronous interval permits the reverse communication, as shown in the first or third isochronous interval of FIG. 4, the master device, after completing the transmitting action in the data broadcast time slot, enters the shared reverse control time slot and performs a receiving action to obtain the reverse control packet BIG RC PDU transmitted by the slave device. If the control packet is required to be transmitted in the current isochronous interval and the current isochronous interval permits the reverse communication, as shown in the second isochronous interval of FIG. 4, the master device, after completing the transmitting action in the data broadcast time slot, first enters the control time slot and completes the action of transmitting the control packet BIG C PDU. Then, the shared reverse control time slot is entered to perform the receiving action. It is to be understood that if the reverse communication is not permitted in the current isochronous interval, the master device may not perform the receiving action in the shared reverse control time slot to save power consumption.

In one embodiment of the present invention, the time domain positions of the shared reverse control time slot and the control time slot in the isochronous interval may be configured in advance. For example, the time domain position of the data broadcast time slot may be configured in advance, and a start time of the control time slot may be pre-defined to be the same as an end time of the data broadcast time slot, and a start time of the shared reverse control time slot may be either the same as an end time of the data broadcast time slot, or the same as the end time of the control time slot. By configuring the reverse communication enable instruction and the control sub-event transmission flag in the BIS packet, the master device can enable the slave devices to accurately know an enabling state and an operating timing of the bidirectional control.

Accordingly, in some specific embodiments, the BLE broadcast communication method further comprises: obtaining the control sub-event transmission flag carried in the BIS packet by the slave device. The control sub-event transmission flag is used to indicate whether the master device transmits the control packet in the isochronous interval.

Under the condition that the control sub-event transmission flag indicates that the master device transmits the control packet in the current isochronous interval, the slave device enters the control time slot after the data broadcast time slot of the current isochronous interval and receives the control packet broadcasted by the master device based on the isochronous channel in the control time slot. Specifically, if the master device does not need to transmit the control packet in the current isochronous interval and the current isochronous interval permits the reverse communication, as shown in the first or third isochronous interval in FIG. 4, the slave device that needs to perform the reverse communication enters the shared reverse control time slot after completing the receiving action in the data broadcast time slot, in order to transmit the reverse control packet BIG RC PDU based on the BLE isochronous channel in the shared reverse control slot. If the master device needs to transmit the control packet in the current isochronous interval and the current isochronous interval permits the reverse communication, as shown in the second isochronous interval in FIG. 4, any one of the slave devices, after completing the receiving action in the data broadcast time slot, enters the control time slot to perform the action of receiving the control packet BIG C PDU. Afterwards, the slave device that is required to perform the reverse communication then enters the shared reverse control slot in order to transmit the reverse control packet BIG RC PDU. It is to be understood that the slave device that is required to perform the reverse communication may not perform the transmitting action in the shared reverse control slot if the reverse communication is not permitted in the current isochronous interval. On the other hand, the slave device that is not required to perform the reverse communication is not required to perform the transmitting action or the receiving action in the shared reverse control time slot, regardless of whether the reverse communication is permitted in the isochronous interval permits or not.

In some other specific embodiments, the control time slot is not provided in the isochronous interval, and the master device may utilize the shared reverse control time slot to transmit the control packet. That is, the shared reverse control time slot is not only a time slot that can be occupied by any of the slave devices when transmitting the reverse control packet, but can also be a time slot that can be occupied by the master device when transmitting the control packet.

The master device flexibly arranges the use of the shared reverse control time slot by configuring the control sub-event transmission flag and the reverse communication enable instruction. For example, when the control sub-event transmission flag is configured to indicate that the master device transmits the control packet in the current isochronous interval, the reverse communication enable instruction is configured to indicate that the reverse communication is not permitted in the current isochronous interval. When the reverse communication enable instruction is configured to indicate that the reverse communication is permitted in the current isochronous interval, the control sub-event transmission flag is configured to indicate that the master device does not transmit the control data packet in the current isochronous interval.

Further, the BLE broadcast communication method further comprises: the master device enters the shared reverse control time slot after the data broadcast time slot of the current isochronous interval and broadcasts the control packet based on the isochronous channel in the shared reverse control time slot when the control sub-event transmission flag indicates that the master device transmits the control packet in the current isochronous interval. Accordingly, all the slave devices enter the shared reverse control time slot after the data broadcast time slot of the current isochronous interval and receive the control packet broadcast by the master device based on the isochronous channel in the shared reverse control time slot.

In this embodiment, the bidirectional control of both the master device and the slave devices are arranged to be completed in the shared reverse control time slot, which can effectively save time slot resources. In some specific embodiments, in order to avoid signal interference caused by multiple slave devices transmitting the reverse control packets at the same time, the slave devices may, when transmitting the reverse control packet, transmit the reverse control packet in the shared reverse control time slot of corresponding isochronous interval after delaying a randomly generated delay time length. Optionally, the delay time length may be an integer multiple of the isochronous interval.

In some specific embodiments, the BIS packet, the control packet and the reverse control packet are all BIS PDU (Protocol Data Unit) formatted packets with modified headers, so as to be compatible with the traditional BLE broadcast system. According to specification of BLE broadcast technology issued by SIG, the BIS PDU transmitted based on the isochronous channel comprises a header and a payload. The header comprises a Logical Link Identifier (LLID) used to indicate a payload type of the BIS PDU, a Control Subevent Sequence Number (CSSN), a Control Subevent Transmission Flag (CSTF), Length of the payload of the BIS PDU, and a reserved field (RFU: Reserved for Future Use) with 2 bits. When the LLID is configured as 0b11, it indicates that the current BIS PDU is a BIS Control PDU used to transmit control information.

In one embodiment of the present invention, the header of the BIS PDU is modified to obtain the BIS packet, the control packet and the reverse control packet in the present invention. The header of the packet in the present invention comprises following flag fields: a first flag field for the master device to configure the reverse communication enable instruction, or for the slave device to configure a reverse communication flag being used to indicate that this packet is the reverse control packet transmitted by the slave device; a second flag field for the master device to configure the control sub-event transmission flag; a third flag field for the master device and the slave device to configure a logical link identifier LLID of a payload type. When the logical link identifier of the packet is configured as a predetermined value, the packet is characterized as the control data packet or the reverse control data packet. As a specific embodiment, the first flag field may be set in the reserved field RFU.

In some specific embodiments, the header of the BIS PDU may be further modified, that is, the header of the packet further comprises an extended field for configuring one or more reverse control flags. The reverse control flags are used by the master device to indicate that reverse control or information feedback of one or more functions are permitted/prohibited, or, alternatively, by the slave device to indicate that reverse control or information feedback of one or more functions are carried in the reverse control packet. The payload of the reverse control packet may be used to carry specific control parameters or feedback data.

One or more bits of the extended field are set to correspond to the one or more functions, respectively. The one or more functions may be set according to specific application scenarios, for example, may comprise one or more of lighting effect control, volume control, media control, transmit power control, version information, and power off control. It is to be understood that the various instructions, flags, and information described above may also be configured in the payload of the BIS PDU.

In the broadcast communication system in the BLE broadcast isochronous stream BIS manner according to one embodiment of the present invention, the BIS packet, the control packet, and the reverse control packet transmitted in the isochronous channel are adopted to realize the bidirectional control of the broadcast communication. The broadcast communication system according to one embodiment of the present invention can be compatible with the traditional Bluetooth broadcast communication system, has a more stable transmission of control information and a more sensitive control response, and can effectively improve the controllability and the user experience.

The following will describe the present invention in detail with reference to a specific application scenario, such as an Auracast Multi-Room Distributed Speaker (MRDS) system. For the convenience of description and understanding, with reference to a naming convention of the Bluetooth technology system for similar technologies, the communication protocol realized by the BLE broadcast communication method according to one embodiment of the present invention is hereinafter referred to as a BIG with Reverse Control (BIGWRC) link protocol. The master device and one or more slave devices establish a reverse control channel through the BIGWRC link protocol, which is convenient for the slave devices to transmit the control command or feedback information, thus improving the controllability of the point-to-multipoint BLE broadcast system and realizing one or more functions of power off control, version control, transmit power control, media control, volume control, or lighting effect control.

The Auracast MRDS system may be shown in FIG. 1, and consists of an MRDS master speaker and an uncertain number of MRDS slave speakers. The master speaker broadcasts audio to the slave speakers via the BIG and PBP protocols. The master speaker and the slave speakers establish a reverse control channel via the BIGWRC link protocol, which is convenient for the slave speakers to transmit the control command to improve the controllability of the Auracast MRDS system.

As shown in FIG. 5, as one specific embodiment, the packet of the BIGWRC link protocol may adopt the header structure in FIG. 5. On the basis of a header of the current BIS PDU, one bit reserved field (RFU: Reserved for Future Use) is set as a Reverse Control Subevent Transmission Flag (RCSTF), the master device configures a value of the RCSTF to configure the reverse communication enable instruction, and the slave device can determine whether or not the reverse communication is permitted in the current isochronous interval based on the RCSTF. The slave device can send the reverse control packet when the master device sets the RCSTF to 1, and the slave device cannot send the reverse control packet when the RCSTF is set to 0. When the slave device transmits the reverse control packet, the RCSTF in the header of the reverse control packet is set to 1. Other fields of the header of the packet of the BIGWRC link protocol have the same function and usage as definitions of the header of the current BIS PDU, and comprises a Logical Link Identifier (LLID) used to indicate the payload type of the BIS PDU, a Control Subevent Sequence Number (CSSN), a Control Subevent Transmission Flag (CSTF), a length of a payload of the BIS PDU, and a RFU with 1 bit. When the CSTF is set to 1, the master device transmits the control packet BIG C PDU in the current isochronous interval, and when the CSTF is set to 0, the master device does not transmit the control packet BIG C PDU in the current isochronous interval. When the LLID is configured as 0b11, it indicates that the current BIS PDU is the BIS Control PDU used for transmitting the control information. Otherwise, the current BIS PDU is a BIS Data PDU. The BIS Control PDU transmitted by the master device is the control packet BIG C PDU, and the BIS Control PDU transmitted by the slave device is the reverse control data packet BIG RC PDU.

When the header of the packet is applied to a specific application scenario in which the bidirectional controls both occupy the shared reverse control time slot, the CSTF and the RCSTF cannot be set to 1 at the same time so that the master device and the slave device can occupy the shared reverse control time slot separately.

When the header of the packet is applied to a specific application scenario in which the bidirectional controls occupy the control time slot and the shared reverse control time slot respectively, the CSTF and the RCSTF can be set to 1 at the same time, i.e., the master device and the slave device transmits the BIG C PDU and the BIG RC PDU at the same isochronous interval in a time division manner. In a specific implementation, as shown in the second isochronous interval shown in FIG. 4, the shared reverse control time slot is provided immediately after the control time slot, such that the slave device transmits the BIG RC PDU immediately after the time slot of the master device transmitting the BIG C PDU.

In another specific embodiment, the packet of the BIGWRC link protocol may also adopt a structure of an extended header as shown in FIG. 6, i.e., the header of the packet also comprises an extended field for configuring one or more reverse control flags. When the master device sets the RCSTF in the header of the BIS packet to 1, in addition to indicating that the slave device can perform the reverse communication at the current isochronous interval, a certain number of bytes are added to the header as the extended field for configuring one or more reverse control flags (RC flags). When the slave device transmits the reverse control packet, it needs to set the RCSTF to 1 and add a certain byte as the extended field.

The structure of the extended field is schematically shown in FIG. 7. Each bit corresponds to enabling a certain reverse control function. One bit of the RC flags of the BIG C PDU transmitted by the master device is set to 1, it indicates that the master device instructs the slave device that it can transmit a control command for the corresponding function. If one bit of the RC flags of the BIG RC PDU transmitted by the slave device is set to 1, it means that the slave device carries the control command of the corresponding function in the payload of the BIG RC PDU. For example, when one byte is added as the RC flags, Bit 0 indicates Lighting Effect (or Lighting Pattern) control, Bit 1 indicates Volume Control, Bit 2 indicates Media Control, Bit 3 indicates Tx Power Control, Bit 4 indicates Version Info, Bit 5 indicates Power Off control, and Bit 6 and Bit 7 are Reserved bits (RFU: Reserved for Future Use).

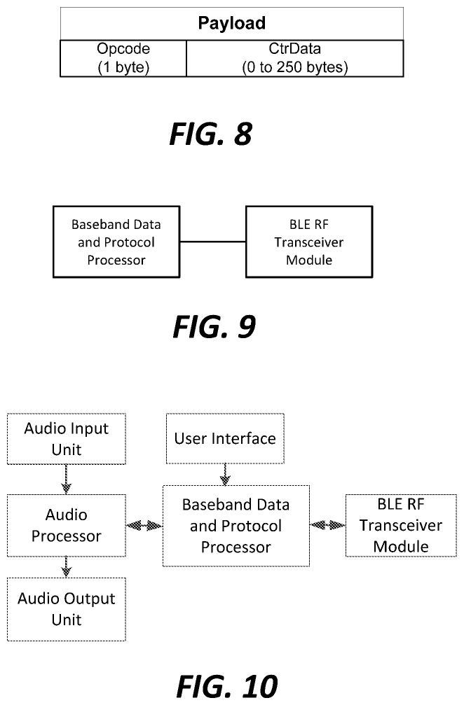

FIG. 8 is a schematic diagram of a payload structure of the BIG Control PDU, which consists of Opcode and CtrData. The Payload, i.e., Opcode and CtrData, are different for different BIG Control PDUs. In the application scenario of the Auracast MRDS system of the present invention, by defining Opcode and CtrData, it is possible to define the BIG Control PDUs corresponding to six commands comprising a lighting pattern command, a volume control command, a media control command, a Tx power control command, and a version Info command, a power off command, respectively.

For example, it is defined that Opcode of the lighting pattern command=0xA0, Opcode of the volume control command=0xA1, Opcode of the media control command=0xA2, Opcode of the Tx power control command=0xA3, Opcode of the Version Info command=0xA4 for, and Opcode of the power off command=0xA5. Further, specific parameters corresponding to different functions are configured by defining their CtrData separately.

For example, the CtrData of the lighting pattern command contains a device address with 6 bytes and a lighting pattern sequence number, and supports up to 256 preset lighting patterns. When any slave speaker needs to control all the devices in the MRDS system to synchronize its own same lighting pattern, it will transmit the BIG RC PDU carrying its lighting pattern sequence number to the master device in the shared reverse control slot, and after receiving the lighting pattern sequence number, the master speaker will transmit it to all the slave devices through the BIG C PDU, so as to synchronize the same lighting pattern.

The CtrData of the volume control command contains a device address with 6 bytes and a volume level with one byte, and supports up to 32 preset volume levels. When any slave speaker needs to control all the speakers in the MRDS system to synchronize its own same volume, it transmits the BIG RC PDU carrying its volume level to the master speaker in the shared reverse control slot, and the master speaker receives the volume level and transmits it to all the slave devices through the BIG C PDU, so as to synchronize the same volume level.

The CtrData of the media control command contains a device address with 6 bytes and a media control data with one byte, and supports 5 controls including Play, Pause, Fast Forward, Previous, and Next. When any slave speaker needs to control the media status of all the speakers in the MRDS system, it transmits the BIG RC PDU carrying the media control command to the master speaker in the shared reverse control slot, and the master speaker receives the media control command and transmits it to all the slave speakers via the BIG C PDU to control the media status of all speakers.

The CtrData of the Tx power control command contains a device address with 6 bytes and a Tx power level with one byte, and supports up to 16 preset Tx power Levels. When any slave speaker needs to control the Tx power level of the master device of the MRDS system, it transmits the BIG RC PDU carrying the Tx power level to the master speaker in the shared reverse control slot, and the master speaker adjusts its own Tx power level after receiving the Tx power level.

The CtrData of the version info command contains a device address with 6 bytes and a version Info with one byte, and supports up to 256 versions. When any slave speaker finds that its PBP version is lower than the PBP version of the master device of the MRDS system and can't play, it will transmit the BIG RC PDU carrying the version info command to the master speaker in the shared reverse control slot, and the master speaker can adjust its own PBP version to be compatible with the above slave speaker after receiving the Version Info.

The CtrData of the power off command contains a device address with 6 bytes and a power off with one byte, and supports power off control. When any slave speaker needs to control all the speakers of the MRDS system to turn off, it transmits the BIG RC PDU carrying the power off command to the master speaker in the shared reverse control time, and after the master speaker receives the power off command, it transmits it to all the slave speakers through the BIG C PDU, so as to control all the speakers to turn off.

The BIG time slot structure based on the BIGWRC link can be shown with reference to FIG. 4, wherein the communication time is divided into a plurality of isochronous intervals (ISO Interval). The box labeled EA represents the extended advertising protocol packet ADV_EXT_IND PDU transmitted by the master device on the primary advertising channel, the box labeled AA represents the auxiliary advertising protocol packet AUX_ADV_IND PDU, and the box labeled SA represents the synchronized auxiliary protocol packet AUX_SYNC_IND PDU carrying the BIGInfo transmitted by the master device on the periodic advertising channel.

In a specific application scenario, according to the BLE audio protocol, the master speaker of the Auracast MRDS system transmits an AUX_SYNC_IND PDU on a periodic advertising channel, wherein main parameters of the BIGInfo may comprise ISO Interval=20 ms, BIS Num=1, NSE=6, BN=2, IRC=6, SDU Size=120 bytes, and Unframed format and LE 2M PHY are adopted. After the master speaker enters an audio playback state, the slave speaker first searches for the ADV_EXT_IND PDU that was transmitted by the master speaker on the primary advertising channel, and acquires information of the AUX_ADV_IND PDU transmitted by the master speaker on the secondary advertising channel; then receives the AUX_ADV_IND PDU, and gets the information of the AUX_SYNC_IND PDU transmitted by the master speaker on the periodic advertising channel; and then receives the synchronization auxiliary protocol packet AUX_SYNC_IND PDU transmitted by the master device on the periodic advertising channel, and obtains the BIG information. Finally, the slave speaker receives the BIS packet transmitted by the master speaker in the data broadcast time slot according to the BIGInfo, decodes the audio data in the BIS packet and plays corresponding audio signal.

In the application scenario of the Auracast MRDS system, the master speaker transmits the BIS packet with the CSTF set to 0 and the RCSTF set to 1, which indicates that the slave device is permitted to transmit the BIG RC PDU in the shared reverse control time slot of the current isochronous interval. Bit 0, Bit 1, Bit 2, Bit 3, Bit 4 and Bit 5 in the RC flags of the BIS packet are all set to 1, that is, the Auracast MRDS system supports realization of lighting effect control, volume control, media control, transmission power control, version control and power off control through the slave speaker.

In the application scenario of the Auracast MRDS system, if any slave speaker synchronizes with the master speaker and wants to turn off the MRDS system, the power off command is input through a user interface of the slave speaker, and the slave speaker transmits the BIG RC PDU carrying the power off command to the master speaker after receiving the power off command. The Bit 5 of the RC flags of the BIG RC PDU carrying the power off command is set to 1, that is, the master speaker is required to execute the power off command. After the master speaker receives the power off command from the slave speaker, it transmits the power off command to all the slave speakers through the BIG C PDU to execute the power off action, so that any slave speaker can realize the reverse power off control through the BIGWRC link.

In the specific application scenario of the Auracast MRDS system, after any slave speaker is synchronized to the master speaker, if it is found that the PBP protocol version of the slave speaker is inconsistent with that of the master speaker and the audio cannot be received or demodulated normally, it can feed back the PBP version information to the master speaker through the BIG RC PDU. The Bit 4 of the RC flags of the BIG RC PDU carrying the version information command is set to 1, so as to inform the master speaker of its own version information (Version Info). After receiving the PBP version information from the slave speaker, the master speaker can decide by itself whether to change the current PBP version to be compatible with the slave speaker, so that any slave speaker can realize the reverse control of the PBP version through the BIGWRC link.

In the application scenario of the Auracast MRDS system, if any slave speaker synchronizes with the master speaker and wants to change the lighting effect (Lighting Pattern) of the MRDS system, the lighting pattern command is input through the user interface of the slave speaker, and the slave speaker receives the lighting pattern command and transmits the BIG RC PDU carrying the lighting pattern command to the master speaker. The Bit 0 of the RC flags of the BIG RC PDU carrying the lighting pattern command is set to 1, which means that the master speaker is requested to execute the lighting pattern command to change the lighting pattern. After the master speaker receives the lighting pattern command from the slave speaker, it transmits the lighting pattern command to all the slave speakers through the BIG C PDU to execute the action of changing the lighting pattern, so that any slave speaker can realize the reverse control of the lighting pattern through the BIGWRC link.

In the application scenario of the Auracast MRDS system, if any slave speaker synchronizes with the master speaker and wants to change a volume of the MRDS system, the volume control command is inputted through the user interface of the slave speaker, and the slave speaker transmits the BIG RC PDU carrying the volume control command to the master speaker after it receives the volume control command to change the volume. The Bit 1 of the RC flags in the extended header of the BIG RC PDU carrying the volume control command is set to 1, that is, the master speaker is requested to execute the volume control command. After the master speaker receives the volume control command from the slave speaker, it transmits the volume control command to all the slave speakers through the BIG C PDU to execute the volume control, so that any slave speaker can realize the reverse control of the volume of the MRDS system through the BIGWRC link.

In the application scenario of the Auracast MRDS system, after any slave speaker synchronizes with the master speaker, if it wants to do media control of the MRDS system, comprising play, pause, fast forward, previous song, next song, etc., the media control command is input through the user interface of the slave speaker. The slave speaker receives the media control command, and then transmits the BIG RC PDU to the master speaker carrying the media control command. The Bit 2 of the RC flags in the extended header of the BIG RC PDU carrying the media control command is set to 1, that is, the master speaker is requested to execute the media control command. When the master speaker receives the media control command from the slave speaker, it executes the media control command so that any slave speaker can realize the media control of the master speaker through the BIGWRC link.

In the application scenario of the Auracast MRDS system, if any slave speaker synchronizes with the master speaker and wants to control the transmit power of the master speaker of the MRDS system, the Tx power control command is received through the user interface of the slave speaker, and the slave speaker transmits the BIG RC PDU carrying the Tx power control command to the master speaker. The Bit 3 of the RC flags in the extended header of the BIG RC PDU carrying the Tx power control command is set to 1, that is, the master speaker is requested to execute the Tx power control command. Upon receiving the Tx power control command from the slave speaker, the master speaker executes the Tx power control command so that any slave speaker can realizes the reverse control of the transmit power of the master speaker through the BIGWRC link.

A BLE broadcast communication device provided according to one embodiment of the present invention is configured to be a master device in the above-described BLE broadcast communication method. The master device is used to perform a broadcast communication with one or more slave devices in a plurality of consecutive isochronous intervals based on an isochronous channel. The isochronous interval is provided with a data broadcast time slot and a shared reverse control time slot. The shared reverse control time slot is a time slot that can be occupied by any one of the slave devices when transmitting the reverse control packet.

The master device is further used to: configure a reverse communication enable instruction in a BIS packet to be broadcast, the reverse communication enable instruction being used to indicate whether a reverse communication is permitted in the current isochronous interval; broadcast the BIS packet in the data broadcast time slot of the current isochronous interval; and receive based on the isochronous channel in the shared reverse control time slot of the current isochronous interval to obtain the reverse control packet transmitted by one of the slave devices when the reverse communication enable instruction indicates that the reverse communication is permitted in the current isochronous interval under the condition that each slave device is not required to be allocated with an exclusive time slot for the reverse communication.

Further, the master device may also be used to accomplish the BLE broadcast communication method of the foregoing embodiments of the present invention, the specific details of which may be referred to in the foregoing description and will not be repeated herein.

A BLE broadcast communication device provided according to one embodiment of the present invention is configured to be used as a slave device in the above-described BLE broadcast communication method. The slave device is used to perform a broadcast communication with a master device in a plurality of consecutive isochronous intervals based on an isochronous channel. The isochronous interval is provided with a data broadcast time slot and a shared reverse control time slot. The shared reverse control time slot is a time slot that is occupiable by any one of the slave devices when transmitting a reverse control packet.

The slave device is further configured to: receive a BIS packet broadcast by the master device in the data broadcast time slot and obtain a reverse communication enable instruction carried in the BIS packet, the reverse communication enable instruction being used to indicate whether a reverse communication is permitted in the current isochronous interval; and transmit a reverse control packet based on the isochronous channel in the shared reverse control time slot when the reverse communication enable instruction indicates that the reverse communication is permitted in the current isochronous interval and the slave device determines that the reverse communication is required under the condition that this slave device is not required to be allocated with an exclusive time slot for the reverse communication. Further, the slave device may also be used to accomplish the BLE broadcast communication method of the foregoing embodiments, the specific details of which may be referred to in the foregoing description and will not be repeated herein.

In one embodiment, as shown in FIG. 9, the master device or the slave device may comprise a baseband data and protocol processor, a BLE radio frequency (RF) transceiver module. The baseband data and protocol processor is used to execute the BLE broadcast communication method described herein and other Bluetooth communication protocols. The BLE RF transceiver module is used for transmitting and receiving BLE RF signals and performing corresponding signal processing.

As shown in FIG. 10, an electronic device provided according to one embodiment of the present invention comprises a user interface, a baseband data and protocol processor, and a BLE RF transceiver module. The electronic device is configured to be used as the aforementioned master device or the aforementioned slave device. The user interface is used to receive a reverse communication setup command input by a user.

The baseband data and protocol processor is configured for controlling the execution of BLE broadcast communication in a plurality of consecutive isochronous intervals, and further for controlling the execution of the above mentioned BLE broadcast communication method. The BLE radio frequency transceiver module is configured for transmitting and receiving BLE wireless signals.

In one embodiment, the electronic device may be implemented as the master speaker, and further comprises an audio input unit and an audio processing unit. The audio input unit acquires a digital audio signal and transmits it to the audio processing unit. The audio processing unit compresses and encodes the digital audio signal into audio data according to the BLE audio protocol. The baseband data and protocol processor execute the BLE audio related protocol and the BIGWRC protocol and processes the audio data into BIS packets suitable for transmitting by the BLE RF transceiver module. The BLE RF transceiver module is used for transmitting and receiving BLE wireless signals or various PDUs, comprising transmitting the BIS C PDU and receiving the BIS RC PDU. The user interface may be a keypad, a touch screen, a wireless control interface, etc. and is used to obtain commands such as the power off control command, the Tx power control command, the media control command, the volume control command, the lighting pattern command, etc.

In another specific embodiment, the electronic device may be implemented as the slave speaker, and further comprises a user interface, an audio output unit and an audio processing unit. The baseband data and protocol processor executes the BLE audio related protocols and the BIGWRC protocol, processes the BIS packets received by the BLE RF transceiver module from the master speaker of a party networking and transmits them to the audio processing unit. The audio processing unit is used for post-processing such as audio decoding, packet loss processing, equalization and sound effects. The audio output unit is used to convert the audio signal into a sound signal. The BLE RF transceiver module is used for transmitting and receiving BLE wireless signal or various PDUs, comprising transmitting the BIS RC PDUs and receiving the BIS C PDUs. The user interface may be a key, a touch screen, a wireless control interface, etc., and is used for obtaining commands such as the power off control command, the Tx power control command, the media control command, the volume control command, the lighting pattern command, and etc.

A chip is provided according to one embodiment of the present invention. The chip comprises: a processing module and a storage module. The storage module stores instructions that can be executed by the processing module. The instructions are executed by the processing module so that the processing module can execute the BLE broadcast communication method in the above embodiments of the present invention. The chip can be applied to the slave device or the master device so as to perform the various processes of the above embodiments and can achieve the same technical effect, which will not be repeated herein to avoid repetition.

In one embodiment, the present invention also provides a computer-readable storage medium having a computer program stored thereon. When the computer program is executed by a processor to realize the BLE broadcast communication method in the above-described embodiments and can achieve the same technical effect, which will not be repeated herein in order to avoid repetition. The computer-readable storage medium can be a read-only memory (ROM), random access memory (RAM), magnetic disc or optical disc, etc.

The embodiments of this application are described above in conjunction with the accompanying drawings, but this application is not limited to the specific embodiments described above, the specific embodiments described above are merely illustrative and not limiting, and the person of ordinary skill in the field of this application, without departing from the purpose of the application and the scope of protection of the claims, may also make many forms, all of which are under the protection of this application.

Although preferred embodiments of the present invention have been described, additional changes and modifications to these embodiments may be made once the basic creative concepts are known to those skilled in the art. The appended claims are therefore intended to be interpreted to comprise preferred embodiments and all changes and modifications falling within the scope of this application.

Obviously, a person skilled in the art may make various changes and variations to the application without departing from the spirit and scope of the application. Thus, if these modifications and variations of this application fall within the scope of the claims and their equivalent technologies, the application is also intended to comprise these changes and variations.

What is claimed is:

1. A BLE broadcast communication method applied to a master device configured to perform a broadcast communication with one or more slave devices in a plurality of consecutive isochronous intervals based on an isochronous channel, the isochronous interval provided with a data broadcast time slot and a shared reverse control time slot being a time slot that is occupiable by any one of the slave devices when transmitting a reverse control packet, the method comprising:
configuring a reverse communication enable instruction in a BIS packet to be broadcast, the reverse communication enable instruction being used to indicate whether a reverse communication is permitted in the current isochronous interval;
broadcasting the BIS packet in the data broadcast time slot; and
receiving based on the isochronous channel in the shared reverse control time slot of the current isochronous interval to obtain the reverse control packet transmitted by one of the slave devices when the reverse communication enable instruction indicates that the reverse communication is permitted in the current isochronous interval under the condition that each slave device is not required to be allocated with an exclusive time slot for the reverse communication.

2. The method according to claim 1, wherein said configuring a reverse communication enable instruction in a BIS packet to be broadcast comprises:
configuring a control sub-event transmission flag in the BIS packet to be broadcast, the control sub-event transmission flag being used to indicate whether the master device transmits a control packet in the current isochronous interval.

3. The method according to claim 2, wherein the isochronous interval is further provided with a control time slot for the master device to broadcast the control packet;
the method further comprises:
entering the control time slot after the data broadcast time slot of the current isochronous interval and broadcasting the control packet based on the isochronous channel in the control time slot when the control sub-event transmission flag indicates that the master device transmits the control packet in the current isochronous interval.

4. The method according to claim 2, wherein a time domain location of the shared reverse control time slot is after the control time slot.

5. The method according to claim 2, wherein the shared reverse control time slot is a time slot that is occupiable when the master device transmits the control packet;
when the control sub-event transmission flag is configured to indicate that the master device transmits the control packet in the current isochronous interval, the reverse communication enable instruction is configured to indicate that the reverse communication is not permitted in the current isochronous interval;
when the reverse communication enable instruction is configured to indicate that the reverse communication is permitted in the current isochronous interval, the control sub-event transmission flag is configured to indicate that the master device does not transmit the control data packet in the current isochronous interval;
the method further comprises:
entering the shared reverse control time slot after the data broadcast time slot in the current isochronous interval and broadcasting the control packet based on the isochronous channel in the shared reverse control time slot when the control sub-event transmission flag indicates that the master device transmits the control packet in the current isochronous interval.

7. The method according to claim 2, wherein the BIS packet, the control packet and the reverse control packet are all BIS PDU formatted packets with modified headers;
the header of the packet comprises:
a first flag field for the master device to configure the reverse communication enable instruction, or for the slave device to configure a reverse communication flag being used to indicate that this packet is the reverse control packet transmitted by the slave device;
a second flag field for the master device to configure the control sub-event transmission flag;
a third flag field for the master device and the slave device to configure a logical link identifier LLID of a payload type, and when the logical link identifier of the packet is configured as a predetermined value, the packet is characterized as the control data packet or the reverse control data packet.

8. The method according to claim 7, wherein the header of the packet further comprises an extended field for configuring one or more reverse control flags being used by the master device to indicate that reverse control or information feedback of one or more functions is permitted/prohibited, or being used by the slave device to indicate that reverse control or information feedback of one or more functions is carried in the reverse control packet.

9. The method according to claim 8, wherein one or more bits of the extended field correspond to the one or more functions respectively,
the one or more functions comprise one or more of lighting effect control, volume control, media control, transmit power control, version information, and power off control.

10. A BLE broadcast communication method applied to a slave device configured to perform a broadcast communication with a master device in a plurality of consecutive isochronous intervals based on an isochronous channel, the isochronous interval provided with a data broadcast time slot and a shared reverse control time slot being a time slot that is occupiable by any one of the slave devices when transmitting a reverse control packet, the method comprising:
receiving a BIS packet broadcast by the master device in the data broadcast time slot and obtaining a reverse communication enable instruction carried in the BIS packet, the reverse communication enable instruction being used to indicate whether a reverse communication is permitted in the current isochronous interval; and
transmitting a reverse control packet based on the isochronous channel in the shared reverse control time slot when the reverse communication enable instruction indicates that the reverse communication is permitted in the current isochronous interval and the slave device determines that the reverse communication is required under the condition that this slave device is not required to be allocated with an exclusive time slot for the reverse communication.

11. The method according to claim 10, further comprising:
obtaining a control sub-event transmission flag carried in the BIS packet, the control sub-event transmission flag being used to indicate whether the master device transmits a control packet in the current isochronous interval.

12. The method according to claim 11, wherein the isochronous interval is further provided with a control time slot for the master device to broadcast the control packet;
the method further comprises:
entering the control time slot after the data broadcast time slot of the current isochronous interval and receiving the control packet broadcast by the master device based on the isochronous channel in the control time slot when the control sub-event transmission flag indicates that the master device transmits the control packet in the current isochronous interval.

13. The method according to claim 11, wherein the shared reverse control time slot is a time slot that is occupiable when the master device transmits the control packet;
the method further comprises:
entering the shared reverse control time slot after the data broadcast time slot in the current isochronous interval and receiving the control packet broadcast by the master device based on the isochronous channel in the shared reverse control time slot when the control sub-event transmission flag indicates that the master device transmits the control packet in the current isochronous interval.

14. The method according to claim 11, wherein the transmitting a reverse control packet based on the isochronous channel in the shared reverse control time slot, comprises:
transmitting the reverse control packet in the shared reverse control time slot of corresponding isochronous interval after delaying a randomly generated delay time length.

15. The method according to claim 11, wherein the BIS packet, the control packet and the reverse control packet are all BIS PDU formatted packets with modified headers;
the header of the packet comprises following flag fields:
a first flag field for the master device to configure the reverse communication enable instruction, or for the slave device to configure a reverse communication flag being used to indicate that this packet is the reverse control packet transmitted by the slave device;
a second flag field for the master device to configure the control sub-event transmission flag;
a third flag field for the master device and the slave device to configure a logical link identifier LLID of a payload type, and when the logical link identifier of the packet is configured as a predetermined value, the packet is characterized as the control data packet or the reverse control data packet.

16. The method according to claim 15, wherein the header of the packet further comprises an extended field for configuring one or more reverse control flags being used by the master device to indicate that reverse control or information feedback of one or more functions is permitted/prohibited, or being used by the slave device to indicate that reverse control or information feedback of one or more functions is carried in the reverse control packet.

17. The method according to claim 16, wherein one or more bits of the extended field correspond to the one or more functions respectively, the one or more functions comprise one or more of lighting effect control, volume control, media control, transmit power control, version information, and power off control.

18. The method according to claim 10, wherein before the receiving a BIS packet broadcast by the master device in the data broadcast time slot, the method further comprises:
searching for an extended advertising protocol packet ADV_EXT_IND PDU broadcast by the master device on a primary advertising channel and obtaining information about an auxiliary advertising protocol packet AUX_ADV_IND PDU broadcast by the master device on a secondary advertising channel;
receiving the auxiliary advertising protocol packet AUX_ADV_IND PDU broadcast by the master device on the secondary advertisement channel, and obtaining information about a synchronization auxiliary protocol packet AUX_SYNC_IND PDU broadcast by the master device on a periodic advertising channel; and
receiving the synchronization auxiliary protocol packet AUX_SYNC_IND PDU broadcast by the master device on the periodic advertising channel, and obtaining BIG information, wherein the BIS packet broadcast by the master device is received according to the BIG information in the data broadcast time slot.

19. A BLE broadcast communication device used as a master device configured to perform a broadcast communication with one or more slave devices in a plurality of consecutive isochronous intervals based on an isochronous channel, the isochronous interval provided with a data broadcast time slot and a shared reverse control time slot being a time slot that is occupiable by any one of the slave devices when transmitting a reverse control packet, the master device is further configured to:
configure a reverse communication enable instruction in a BIS packet to be broadcast, the reverse communication enable instruction being used to indicate whether a reverse communication is permitted in the current isochronous interval;
broadcast the BIS packet in the data broadcast time slot; and
receive based on the isochronous channel in the shared reverse control time slot of the current isochronous interval to obtain the reverse control packet transmitted by one of the slave devices when the reverse communication enable instruction indicates that the reverse communication is permitted in the current isochronous interval under the condition that each slave device is not required to be allocated with an exclusive time slot for the reverse communication.

20. The BLE broadcast communication device according to claim 19, wherein the master device is further configured to:
configure a control sub-event transmission flag in the BIS packet to be broadcast, the control sub-event transmission flag being used to indicate whether the master device transmits a control packet in the current isochronous interval.
